(19) United States
(12) Patent Application Publication
(10) Pub. No.: US 2014/0057598 A1
(43) Pub. Date: Feb. 27, 2014

(54) AUTOMATIC ACCESS TO NETWORK NODES

(71) Applicants: David G. Steer, Napean (CA); William Anthony Gage, Stittsville (CA); Daniel Noel Badiere, Ottawa (CA)

(72) Inventors: David G. Steer, Napean (CA); William Anthony Gage, Stittsville (CA); Daniel Noel Badiere, Ottawa (CA)

(73) Assignee: RESEARCH IN MOTION LIMITED, Waterloo, ON (CA)

(21) Appl. No.: 13/809,791

(22) PCT Filed: May 13, 2011
(86) PCT No.: PCT/CA2011/050300

§ 371 Date: Jan. 11, 2013

(51) Int. Cl. H04W 12/06

(52) U.S. Cl. CPC H04W 12/06
USPC 455/411

(57) ABSTRACT

Devices and methods are provided for automating client node access of a wireless network access node. A client node comprises a database containing identification data and access procedure data associated with a plurality of wireless network access nodes and credentials data associated with the client node. The client node receives identification data associated with a wireless network access node. The client node then processes the identification data to locate access procedure data in the database corresponding to the wireless network access node. Once identified, the client node then uses the access procedure data to provide its credential data to the wireless network access node. In response, the wireless network access node processes the credential data for approval, and once it is approved, grants the client node access.

### PRIORITY

This is a U.S. national stage of application No.: PCT/CA2011/050300, filed on May 13, 2011. All the benefits accruing therefrom under 35 U.S.C §119, the contents of which in its entirety are herein incorporated by reference.

### BACKGROUND

It has become common in recent years for client nodes, such as smart phones and other mobile devices, to support multiple wireless communication technologies. As an example, many devices are able to connect to different wide area mobile network facilities, such as cellular networks, as well as wireless local area networks (WLAN).

However, accessing a wireless network access node, such as part of a WLAN, often requires various manual operations by the client node user. For example, the user may need to manually select an available network and then enter a user name and password. This process is often required even if the user's mobile network and the WLAN are operated by the same entity. Furthermore, the user typically must have knowledge of local business arrangements and an account with the provider of the WLAN. In many cases, the user does not have a local account and may be unwilling to provide financial information (e.g. credit card) to an unknown WLAN provider.

Known approaches to this issue include the provision of a “profile” that is used for automating the process of accessing a WLAN, such as an enterprise access point. However, such access profiles are not standardized, nor are they supported by all WLAN access points. Furthermore, those that do, require the user to individually pre-assign their access profile with each WLAN access point. Moreover, such access profiles are typically established manually by the user, which can be a tedious, time consuming, and error-prone process. As a result, there is no current way to automatically access WLANs that require user interaction such as entry of a user name, password and financial credentials.

### BRIEF DESCRIPTION OF THE DRAWINGS

The present disclosure may be understood, and its numerous objects, features and advantages obtained, when the following detailed description is considered in conjunction with the following drawings, in which:

FIG. 1 depicts an exemplary client node in which the present disclosure may be implemented;

FIG. 2 shows a wireless communications system including an embodiment of a client node;

FIG. 3 is a simplified block diagram of an exemplary client node comprising a digital signal processor (DSP);

FIG. 4 is a simplified block diagram of a software environment that may be implemented by the DSP;

FIG. 5 is a generalized block diagram illustrating the automated access of a wireless network access node by a client node; and

FIGS. 6a, 6b and 6c are simplified flow charts of operations associated with automating the access of a wireless network access node by a client node.

### DETAILED DESCRIPTION

The present disclosure is directed in general to wireless communications systems and methods for operating same. In one aspect, the present disclosure relates to devices and methods for automating client node access to a wireless network access node.

Devices and methods are provided for automating client node access of a wireless network access node. In various embodiments, the wireless network access node may be in a fixed location and associated with a local network. In other embodiments the wireless network access node may be located in a vehicle and be able to access a communications network while the vehicle is in motion through coverage areas of various networks. In these and other embodiments, a client node comprises a database containing identification data and access procedure data associated with a plurality of wireless network access nodes and credentials data associated with the client node. In various embodiments, different sets of credentials data may be associated with different sets of wireless network access nodes. In these various embodiments, the client node receives identification data associated with a wireless network access node. The client node then processes the identification data to locate access procedure data and credentials data in the database corresponding to the wireless network access node. Once identified, the client node then uses the access procedure data to provide the credential data to the wireless network access node. In response, the wireless network access node processes the credential data for approval, and once it is approved, grants the client node access to the wireless network.

In one embodiment, the access procedure data corresponding to the wireless network access node is not present in the client node's database. In this embodiment, the client node provides the identification data to a remote server. In response, the server provides the client node access procedure data corresponding to the wireless network access node, and if required, credential data corresponding to the wireless network access node for use by the client node. In turn, the client node then uses the provided access procedure data to provide the credential data to the wireless network access node. In response the wireless network access node receives the credential data, processes it for approval, and once it is approved, grants the client node access to the wireless network.

In various embodiments, the client node receives identification data corresponding to a plurality of wireless network access nodes. In one embodiment, a list of the plurality of wireless network access nodes is displayed on a display of the client node. A user of the client node then selects an individual wireless access node from the displayed list. In turn, the client node processes the access procedure data corresponding to the selected wireless access node to provide the corresponding credential data and automatically initiates a communications session with the selected wireless access node. In another embodiment, the client node automatically selects a wireless access node from the plurality of wireless network access nodes. The client node then processes the access procedure data corresponding to the automatically selected wireless access node to provide the corresponding credential data and automatically initiates a communications session with the selected wireless access node. In another embodiment, the remote server selects a wireless access node from the plurality of wireless network access nodes using the identification data sent to the remote server by the client node. The client node then processes the access procedure data corresponding to the selected wireless access node to provide the corresponding credential data and automatically initiates a communications session with the selected wireless access node.

In yet another embodiment, the remote server communicates with the wireless network access node, or the wireless network access node's associated controller, to exchange access procedures and credentials and the traffic loading conditions of the wireless network access node and its associated network. In this and other embodiments, the remote server may use the traffic loading information to select from multiple network access nodes. In still another embodiment, the client node notifies the remote server of its location, and if there are suitable wireless access nodes available at that location, the remote server provides access procedure data corresponding to the wireless network access node to the client node. In turn, the client node uses the access procedure data to automatically initiate a communications session with the selected wireless access node.

Various illustrative embodiments of the present disclosure will now be described in detail with reference to the accompanying figures. While various details are set forth in the following description, it will be appreciated that the present disclosure may be practiced without these specific details, and that numerous implementation-specific decisions may be made to the disclosure described herein to achieve the inventor's specific goals, such as compliance with process technology or design-related constraints, which will vary from one implementation to another. While such a development effort might be complex and time-consuming, it would nevertheless be a routine undertaking for those of skill in the art having the benefit of this disclosure. For example, selected aspects are shown in block diagram and flow chart form, rather than in detail, in order to avoid limiting or obscuring the present disclosure. In addition, some portions of the detailed descriptions provided herein are presented in terms of algorithms or operations on data within a computer memory. Such descriptions and representations are used by those skilled in the art to describe and convey the substance of their work to others skilled in the art.

As used herein, the terms “component,” “system” and the like are intended to refer to a computer-related entity, either hardware, a combination of hardware and software, software, software in execution. For example, a component may be, but is not limited to being, a process running on a processor, a processor, an object, an executable, a thread of execution, a program, or a computer. By way of illustration, both an application running on a computer and the computer itself can be a component. One or more components may reside within a process or thread of execution and a component may be localized on one computer or distributed between two or more computers.

As likewise used herein, the term “node” broadly refers to a connection point, such as a redistribution point or a communication endpoint, of a communication environment, such as a network. Accordingly, such nodes refer to an active electronic device capable of sending, receiving, or forwarding information over a communications channel Examples of local area network (LAN) or wide area network (WAN) nodes include computers, packet switches, cable modems, Data Subscriber Line (DSL) modems, and wireless LAN (WLAN) access points.

Examples of Internet or Intranet nodes include host computers identified by an Internet Protocol (IP) address, bridges and WLAN access points. Likewise, examples of nodes in cellular communication include base stations, relays, base station controllers, home location registers, Gateway GPRS Support Nodes (GGSN), and Serving GPRS Support Nodes (SGSN).

Other examples of nodes include client nodes, server nodes, peer nodes and access nodes. As used herein, a client node may refer to wireless devices such as mobile telephones, smart phones, personal digital assistants (PDAs), handheld devices, portable computers, tablet computers, and similar devices or other user equipment (UE) that has telecommunications capabilities. Such client nodes may likewise refer to a mobile, wireless device, or conversely, to devices that have similar capabilities that are not generally transportable, such as desktop computers, set-top boxes, or sensors. Likewise, a server node, as used herein, refers to an information processing device (e.g., a host computer), or series of information processing devices, that perform information processing requests submitted by other nodes. As likewise used herein, a peer node may sometimes serve as client node, and at other times, a server node. In a peer-to-peer or overlay network, a node that actively routes data for other networked devices as well as itself may be referred to as a supernode.

An access node, as used herein, refers to a node that provides a client node access to a communication environment. Examples of access nodes include cellular network base stations and wireless broadband (e.g., WiFi, WiMAX, etc) access points, which provide corresponding cell and WLAN coverage areas.

The term “article of manufacture” (or alternatively, “computer program product”) as used herein is intended to encompass a computer program accessible from any computer-readable device or media. For example, computer readable media can include but are not limited to magnetic storage devices (e.g., hard disk, floppy disk, magnetic strips, etc.), optical disks such as a compact disk (CD) or digital versatile disk (DVD), smart cards, and flash memory devices (e.g., card, stick, etc.).

The word “exemplary” is used herein to mean serving as an example, instance, or illustration. Any aspect or design described herein as “exemplary” is not necessarily to be construed as preferred or advantageous over other aspects or designs. Those of skill in the art will recognize many modifications may be made to this configuration without departing from the scope, spirit or intent of the claimed subject matter. Furthermore, the disclosed subject matter may be implemented as a system, method, apparatus, or article of manufacture using standard programming and engineering techniques to produce software, firmware, hardware, or any combination thereof to control a computer or processor-based device to implement aspects detailed herein.

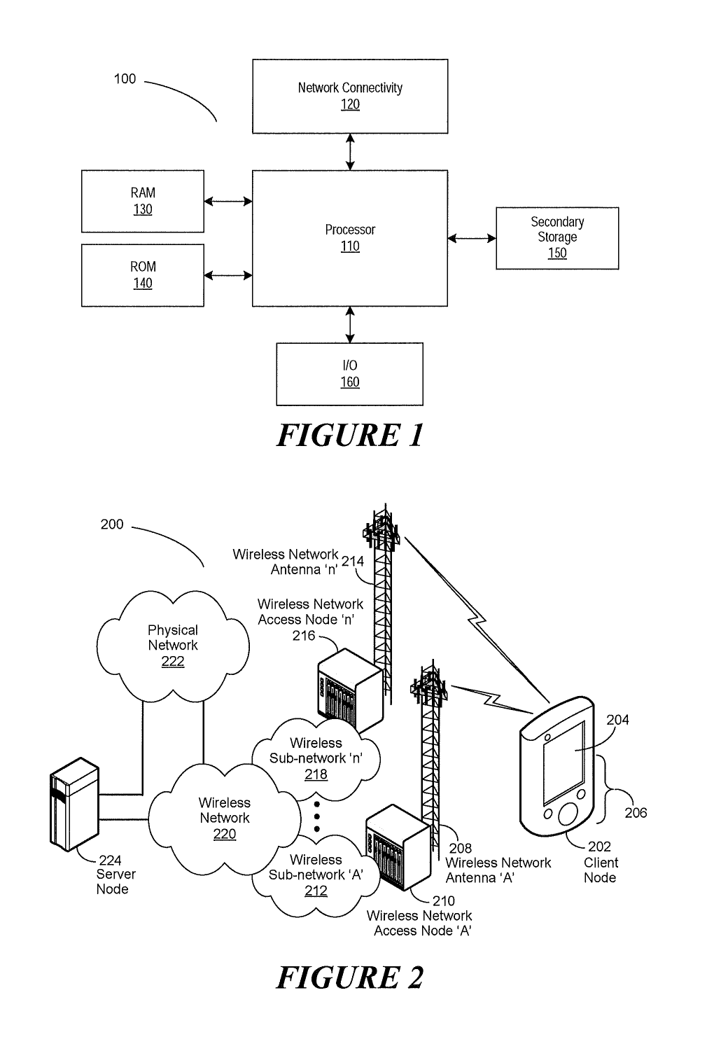

FIG. 1 illustrates an example of a node 100 suitable for implementing one or more embodiments disclosed herein. In various embodiments, the node 100 comprises a processor 110, which may be referred to as a central processor unit (CPU) or digital signal processor (DSP), network connectivity devices 120, random access memory (RAM) 130, read only memory (ROM) 140, secondary storage 150, and input/output (I/O) devices 160. In some embodiments, some of these components may not be present or may be combined in various combinations with one another or with other components not shown. These components may be located in a single physical entity or in more than one physical entity. Any actions described herein as being taken by the processor 110 might be taken by the processor 110 alone or by the processor 110 in conjunction with one or more components shown or not shown in FIG. 1.

The processor 110 executes instructions, codes, computer programs, or scripts that it might access from the network connectivity devices 120, RAM 130, or ROM 140. While only one processor 110 is shown, multiple processors may be present. Thus, while instructions may be discussed as being executed by a processor 110, the instructions may be executed simultaneously, serially, or otherwise by one or multiple processors 110 implemented as one or more CPU chips.

In various embodiments, the network connectivity devices 120 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, long term evolution (LTE) radio transceiver devices, worldwide interoperability for microwave access (WiMAX) devices, and/or other well-known devices for connecting to networks, including Personal Area Networks (PANs) such as Bluetooth. These network connectivity devices 120 may enable the processor 110 to communicate with the Internet or one or more telecommunications networks or other networks from which the processor 110 might receive information or to which the processor 110 might output information.

The network connectivity devices 120 may also be capable of transmitting or receiving data wirelessly in the form of electromagnetic waves, such as radio frequency signals or microwave frequency signals. Information transmitted or received by the network connectivity devices 120 may include data that has been processed by the processor 110 or instructions that are to be executed by processor 110. The data may be ordered according to different sequences as may be desirable for either processing or generating the data or transmitting or receiving the data.

In various embodiments, the RAM 130 may be used to store volatile data and instructions that are executed by the processor 110. The ROM 140 shown in FIG. 1 may be used to store instructions and perhaps data that are read during execution of the instructions. Access to both RAM 130 and ROM 140 is typically faster than to secondary storage 150. The secondary storage 150 is typically comprised of one or more disk drives or tape drives and may be used for non-volatile storage of data or as an over-flow data storage device if RAM 130 is not large enough to hold all working data. Secondary storage 150 may be used to store programs that are loaded into RAM 130 when such programs are selected for execution. The I/O devices 160 may include liquid crystal displays (LCDs), Light Emitting Diode (LED) displays, Organic Light Emitting Diode (OLED) displays, projectors, televisions, touch screen displays, keyboards, keypads, switches, dials, mice, track balls, voice recognizers, card readers, paper tape readers, printers, video monitors, or other well-known input/output devices.

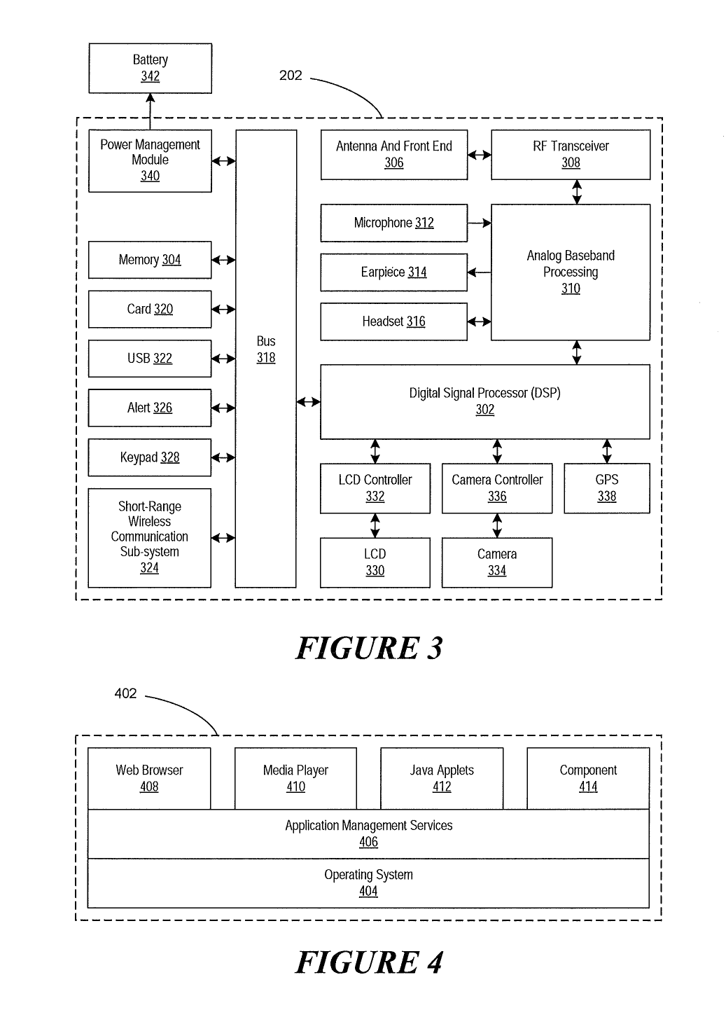

FIG. 2 shows a wireless-enabled communications environment including an embodiment of a client node as implemented in an embodiment of the disclosure. Though illustrated as a mobile phone, the client node 202 may take various forms including a wireless handset, a pager, a smart phone, or a personal digital assistant (PDA). In various embodiments, the client node 202 may also comprise a portable computer, a tablet computer, a laptop computer, or any computing device operable to perform data communication operations. Many suitable devices combine some or all of these functions. In some embodiments, the client node 202 is not a general purpose computing device like a portable, laptop, or tablet computer, but rather is a special-purpose communications device such as a telecommunications device installed in a vehicle. The client node 202 may likewise be a device, include a device, or be included in a device that has similar capabilities but that is not transportable, such as a desktop computer, a set-top box, or a network node. In these and other embodiments, the client node 202 may support specialized activities such as gaming, inventory control, job control, task management functions, and so forth.

In various embodiments, the client node 202 includes a display 204. In these and other embodiments, the client node 202 may likewise include a touch-sensitive surface, a keyboard or other input keys 206 generally used for input by a user. The input keys 206 may likewise be a full or reduced alphanumeric keyboard such as QWERTY, Dvorak, AZERTY, and sequential keyboard types, or a traditional numeric keypad with alphabet letters associated with a telephone keypad. The input keys 206 may likewise include a trackwheel, an exit or escape key, a trackball, and other navigational or functional keys, which may be inwardly depressed to provide further input function. The client node 202 may likewise present options for the user to select, controls for the user to actuate, and cursors or other indicators for the user to direct.

The client node 202 may further accept data entry from the user, including numbers to dial or various parameter values for configuring the operation of the client node 202. The client node 202 may further execute one or more software or firmware applications in response to user commands. These applications may configure the client node 202 to perform various customized functions in response to user interaction. Additionally, the client node 202 may be programmed or configured over-the-air (OTA), for example from a wireless network access node ‘A’ 210 through ‘n’ 216 (e.g., a base station), a server node 224 (e.g., a host computer), or a peer client node 202.

Among the various applications executable by the client node 202 are a web browser, which enables the display 204 to display a web page. The web page may be obtained from a server node 224 through a wireless connection with a wireless network 220. The various applications may likewise be obtained from a peer client node 202 or other system over a connection to the wireless network 220 or any other wireless communication network or system. In various embodiments, the wireless network 220 comprises a plurality of wireless sub-networks (e.g., cells with corresponding coverage areas) ‘A’ 212 through ‘n’ 218. In these and other embodiments, the client node 202 transmits and receives communication signals, which are respectively communicated to and from the wireless network nodes ‘A’ 210 through ‘n’ 216 by wireless network antennas ‘A’ 208 through ‘n’ 214 (e.g., cell towers). In turn, the communication signals are used by the wireless network access nodes ‘A’ 210 through ‘n’ 216 to establish a wireless communication session with the client node 202. In turn, the wireless network access points ‘A’ 210 through ‘n’ 216 are respectively coupled to wireless sub-networks ‘A’ 212 through ‘n’ 218, which are connected to the wireless network 220.

In various embodiments, the wireless network 220 is coupled to a wired network 222, such as the Internet. Via the wireless network 220 and the wired network 222, the client node 202 has access to information on various hosts, such as the server node 224. In these and other embodiments, the server node 224 may provide content that may be shown on the display 204 or used by the client node processor 110 for its operations. Alternatively, the client node 202 may access the wireless network 220 through a peer client node 202 acting as an intermediary, in a relay type or hop type of connection. As another alternative, the client node 202 may be tethered and obtain its data from a linked device that is connected to the wireless network 212. Skilled practitioners of the art will recognize that many such embodiments are possible and the foregoing is not intended to limit the spirit, scope, or intention of the disclosure.

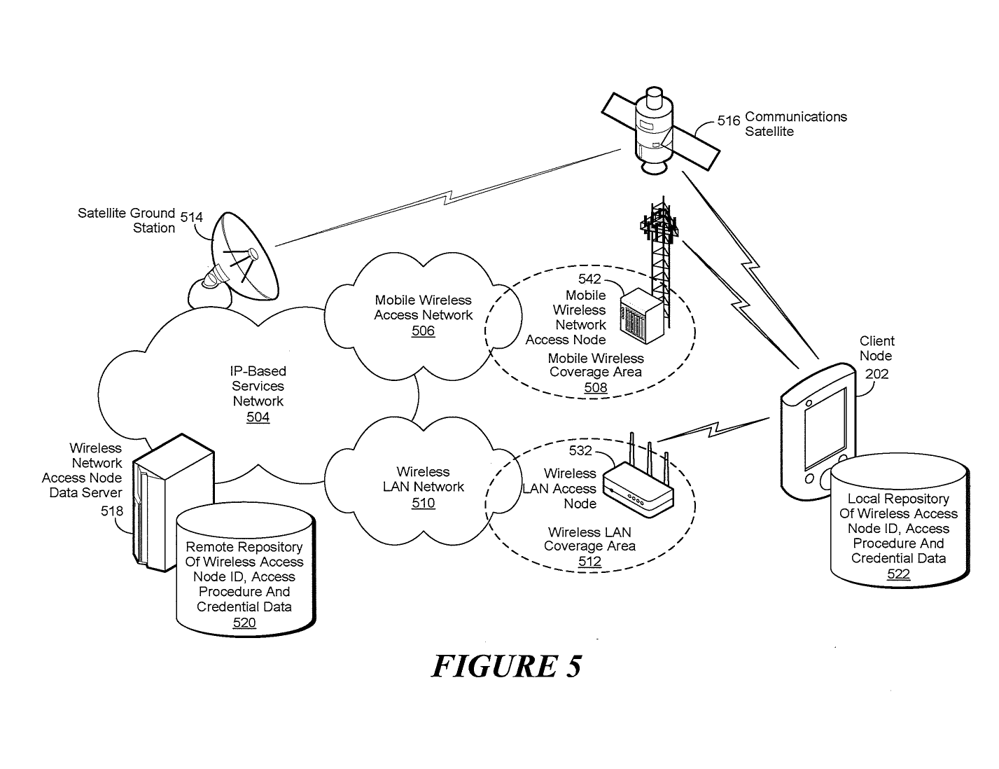

FIG. 3 depicts a block diagram of an exemplary client node as implemented with a digital signal processor (DSP) in accordance with an embodiment of the disclosure. While various components of a client node 202 are depicted, various embodiments of the client node 202 may include a subset of the listed components or additional components not listed. As shown in FIG. 3, the client node 202 includes a DSP 302 and a memory 304. As shown, the client node 202 may further include an antenna and front end unit 306, a radio frequency (RF) transceiver 308, an analog baseband processing unit 310, a microphone 312, an earpiece speaker 314, a headset port 316, a bus 318, such as a system bus or an input/output (I/O) interface bus, a removable memory card 320, a universal serial bus (USB) port 322, a short range wireless communication sub-system 324, an alert 326, a keypad 328, a liquid crystal display (LCD) 330, which may include a touch sensitive surface, an LCD controller 332, a charge-coupled device (CCD) camera 334, a camera controller 336, and a global positioning system (GPS) sensor 338, and a power management module 340 operably coupled to a power storage unit, such as a battery 342. In various embodiments, the client node 202 may include another kind of display that does not provide a touch sensitive screen. In one embodiment, the DSP 302 communicates directly with the memory 304 without passing through the input/output interface 318.

In various embodiments, the DSP 302 or some other form of controller or central processing unit (CPU) operates to control the various components of the client node 202 in accordance with embedded software or firmware stored in memory 304 or stored in memory contained within the DSP 302 itself. In addition to the embedded software or firmware, the DSP 302 may execute other applications stored in the memory 304 or made available via information carrier media such as portable data storage media like the removable memory card 320 or via wired or wireless network communications. The application software may comprise a compiled set of machine-readable instructions that configure the DSP 302 to provide the desired functionality, or the application software may be high-level software instructions to be processed by an interpreter or compiler to indirectly configure the DSP 302.

The antenna and front end unit 306 may be provided to convert between wireless signals and electrical signals, enabling the client node 202 to send and receive information from a cellular network or some other available wireless communications network or from a peer client node 202. In an embodiment, the antenna and front end unit 106 may include multiple antennas to support beam forming and/or multiple input multiple output (MIMO) operations. As is known to those skilled in the art, MIMO operations may provide spatial diversity which can be used to overcome difficult channel conditions or to increase channel throughput. Likewise, the antenna and front end unit 306 may include antenna tuning or impedance matching components, RF power amplifiers, or low noise amplifiers.

In various embodiments, the RF transceiver 308 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 310 or the DSP 302 or other central processing unit. In some embodiments, the RF Transceiver 108, portions of the Antenna and Front End 306, and the analog base band processing unit 310 may be combined in one or more processing units and/or application specific integrated circuits (ASICs).

The analog baseband processing unit 310 may provide various analog processing of inputs and outputs, for example analog processing of inputs from the microphone 312 and the headset 316 and outputs to the earpiece 314 and the headset 316. To that end, the analog baseband processing unit 310 may have ports for connecting to the built-in microphone 312 and the earpiece speaker 314 that enable the client node 202 to be used as a cell phone. The analog baseband processing unit 310 may further include a port for connecting to a headset or other hands-free microphone and speaker configuration. The analog baseband processing unit 310 may provide digital-to-analog conversion in one signal direction and analog-to-digital conversion in the opposing signal direction. In various embodiments, at least some of the functionality of the analog baseband processing unit 310 may be provided by digital processing components, for example by the DSP 302 or by other central processing units.

The DSP 302 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 302 may perform modulation, coding, interleaving, and spreading, and for a receiver function the DSP 302 may perform despreading, deinterleaving, decoding, and demodulation. In another embodiment, for example in an orthogonal frequency division multiplex access (OFDMA) technology application, for the transmitter function the DSP 302 may perform modulation, coding, interleaving, inverse fast Fourier transforming, and cyclic prefix appending, and for a receiver function the DSP 302 may perform cyclic prefix removal, fast Fourier transforming, deinterleaving, decoding, and demodulation. In other wireless technology applications, yet other signal processing functions and combinations of signal processing functions may be performed by the DSP 302.

The DSP 302 may communicate with a wireless network via the analog baseband processing unit 310. In some embodiments, the communication may provide Internet connectivity, enabling a user to gain access to content on the Internet and to send and receive e-mail or text messages. The input/output interface 318 interconnects the DSP 302 and various memories and interfaces. The memory 304 and the removable memory card 320 may provide software and data to configure the operation of the DSP 302. Among the interfaces may be the USB interface 322 and the short range wireless communication sub-system 324. The USB interface 322 may be used to charge the client node 202 and may also enable the client node 202 to function as a peripheral device to exchange information with a personal computer or other computer system. The short range wireless communication sub-system 324 may include an infrared port, a Bluetooth interface, an IEEE 802.11 compliant wireless interface, or any other short range wireless communication sub-system, which may enable the client node 202 to communicate wirelessly with other nearby client nodes and access nodes.

The input/output interface 318 may further connect the DSP 302 to the alert 326 that, when triggered, causes the client node 202 to provide a notice to the user, for example, by ringing, playing a melody, or vibrating. The alert 326 may serve as a mechanism for alerting the user to any of various events such as an incoming call, a new text message, and an appointment reminder by silently vibrating, or by playing a specific pre-assigned melody for a particular caller.

The keypad 328 couples to the DSP 302 via the I/O interface 318 to provide one mechanism for the user to make selections, enter information, and otherwise provide input to the client node 202. The keyboard 328 may be a full or reduced alphanumeric keyboard such as QWERTY, Dvorak, AZERTY and sequential types, or a traditional numeric keypad with alphabet letters associated with a telephone keypad. The input keys may likewise include a trackwheel, an exit or escape key, a trackball, and other navigational or functional keys, which may be inwardly depressed to provide further input function. Another input mechanism may be the LCD 330, which may include touch screen capability and also display text and/or graphics to the user. The LCD controller 332 couples the DSP 302 to the LCD 330.

The CCD camera 334, if equipped, enables the client node 202 to take digital pictures. The DSP 302 communicates with the CCD camera 334 via the camera controller 336. In another embodiment, a camera operating according to a technology other than Charge Coupled Device cameras may be employed. The GPS sensor 338 is coupled to the DSP 302 to decode global positioning system signals or other navigational signals, thereby enabling the client node 202 to determine its position. Various other peripherals may also be included to provide additional functions, such as radio and television reception.

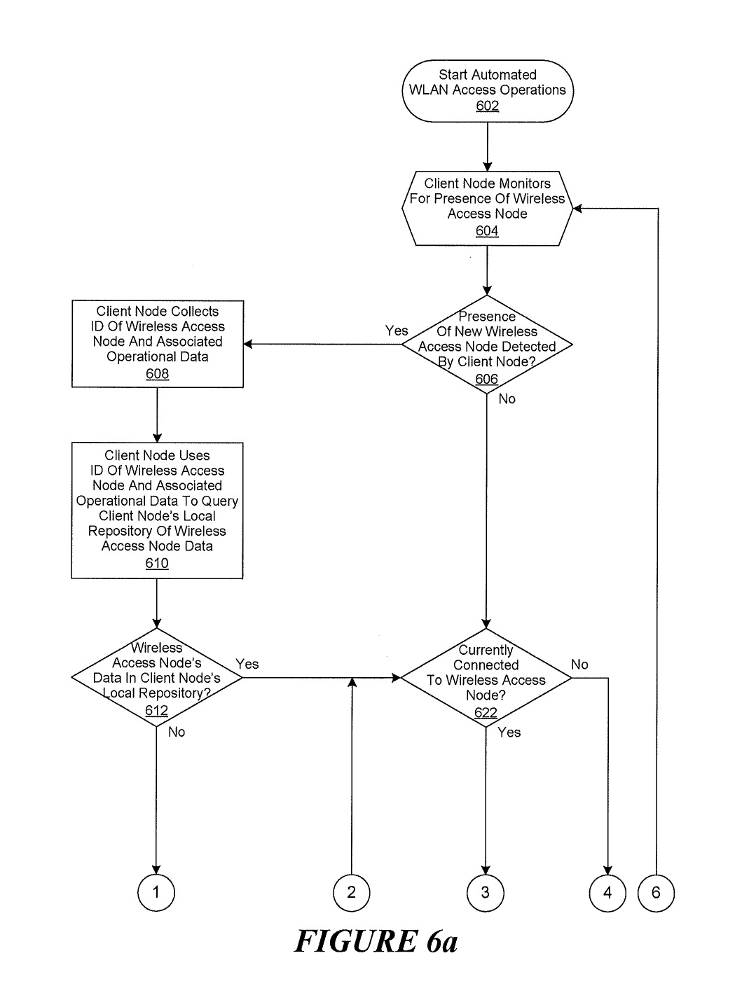

FIG. 4 illustrates a software environment 402 that may be implemented by a digital signal processor (DSP). In this embodiment, the DSP 302 shown in FIG. 3 executes an operating system 404, which provides a platform from which the rest of the software operates. The operating system 404 likewise provides the client node 202 hardware with standardized interfaces (e.g., drivers) that are accessible to application software. The operating system 404 likewise comprises application management services (AMS) 406 that transfer control between applications running on the client node 202. Also shown in FIG. 4 are a web browser application 408, a media player application 410, and Java applets 412. The web browser application 408 configures the client node 202 to operate as a web browser, allowing a user to enter information into forms and select links to retrieve and view web pages. The media player application 410 configures the client node 202 to retrieve and play audio or audiovisual media. The Java applets 412 configure the client node 202 to provide games, utilities, and other functionality. A component 414 may provide functionality described herein. In various embodiments, the client node 202, the wireless network nodes ‘A’ 210 through ‘n’ 216, and the server node 224 shown in FIG. 2 may likewise include a processing component that is capable of executing instructions related to the actions described above.

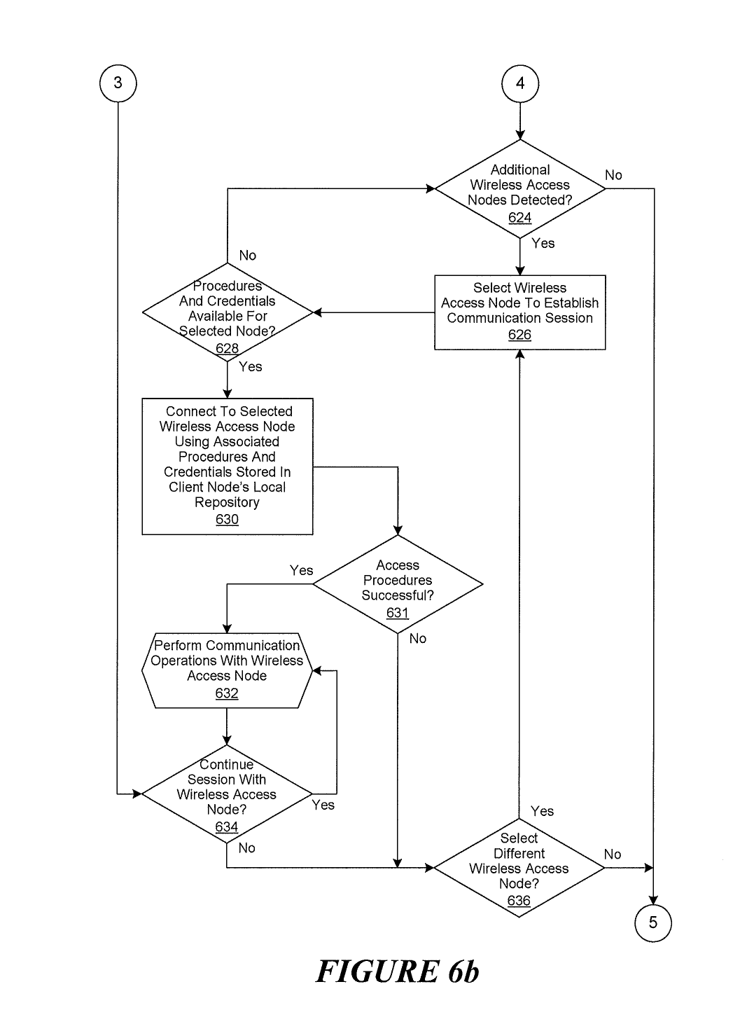

FIG. 5 is a generalized block diagram illustrating the automated access of a wireless network access node by a client node as implemented in accordance with an embodiment of the disclosure. In various embodiments, a client node 202 automatically accesses communication facilities provided by a wireless LAN network 510, such as when leaving the mobile wireless coverage area 508 of a mobile wireless access network 506 and moving into the wireless LAN coverage area 512. Those of skill in the art will recognize that moving from the mobile wireless coverage area 508 to the wireless LAN coverage area 512 typically requires establishment of a new communications session between the client node 202 and the wireless LAN access node 532. Accordingly, the user of the client node 202 is required to follow a series of access procedures that generally entail the provisions of identity and payment credentials.

As used herein, a wireless network broadly refers to any network with a plurality of nodes using at least one wireless connection between at least two of its nodes. Accordingly, the mobile wireless access network 506 and the wireless LAN access network 510 both refer to a wireless network. Likewise, a wireless network access node, as used herein, broadly refers to any access node of a wireless network. Accordingly, the mobile wireless network access node 542 and the wireless LAN access node 532 both refer to a wireless network access node.

In this and other embodiments, the client node 202 comprises a local repository 522 of wireless network access node identifier (ANID), access procedure, and credential data. Alternatively, the local repository 522 may comprise service provider identifier (SPID), access procedure, and credential data. In these various embodiments, the mobile wireless access network 506 and wireless LAN access network 510 are connected to an Internet Protocol (IP)-based services network 504, such as the Internet or a private enterprise network. In various embodiments, the IP-based services network 504 comprises a wireless network access data server 518, which in turn comprises a remote repository of wireless network access node identifier (ANID), access procedure and credential data 520. Alternatively, the network access data server 518 comprises a remote repository of service provider identifier (SPID), access procedure and credential data 520, the service provider identifier (SPID) comprising one or more of a business identifier, a venue identifier, or a network identifier. In certain of these various embodiments, the IP-based services network 504 likewise comprises a satellite ground station 514 operable to initiate, and subsequently conduct, a communications session with a communications satellite 516. In turn, the communications satellite 516 is operable to initiate, and subsequently conduct, a communications session with the client node 202.

In this embodiment, automated wireless network access operations are initiated by the client node 202 performing monitoring operations to detect the presence of a wireless network access node; for example, the client node 202 may enter the WLAN coverage area 512 and detect the presence of WLAN access node 532. Once the wireless LAN access node 532 is detected, then the client node 202 collects identification (ANID, or SPID, or both), and associated operational data, related to the wireless LAN access node 532. As an example, such identification and associated operational data may include the wireless network access node's implemented radio access technology (RAT), its venue information, its roaming consortium identifier, its network authentication type, its domain name, its civic location, its geospatial location, its list of subscription service providers, it's access network type, its Service Set Identifier (SSID), its Media Access Control (MAC) address, its signal strength, its wide area cell site identification, and its location, which may be derived from the client node's 202 geographical positioning system (GPS) coordinates. To further the example, the client node's location may be determined by processing information associated with multiple signals corresponding to multiple wireless network access nodes that are within its communication range.

In this and other embodiments, the client node 202 uses the wireless LAN access node's 532 identification and associated data to query its local repository 522 of wireless network access procedures and credentials data. If the wireless LAN access node's 532 identification and associated data is stored in the client node's 202 local repository 522 of wireless network access procedures and credentials data, then it can be used by the client node 202 to access the wireless LAN access node 532. However, if the wireless LAN access node's 532 identification and associated data is not stored in the client node's 202 local repository 522 of wireless network access procedures and credentials data, then the client node 202 submits the wireless LAN access node's 532 identification and associated data as a query to the remote repository 520 of wireless network access procedures and credentials data.

In one embodiment, the remote repository of wireless network access procedures and credentials data 520 is implemented on a mobile wireless access node 542 of the mobile wireless access network 506. In another embodiment, the remote repository 520 of wireless network access procedures and credentials data is implemented on the IP-based services network 504. In yet another embodiment, the remote repository 520 of wireless network access procedures and credentials data is implemented on another client node with which the client node 202 is able to communicate. The client node 202 may identify itself to the remote repository 520 by sending an client identification number, together with the repository query. The communication with the remote repository 520 may likewise include an authentication interaction between the repository 520 and the client node 202 to verify its authenticity. Those of skill in the art will recognize that many such embodiments are possible and the foregoing is not intended to limit the spirit, scope, or intent of the disclosure.

If the wireless LAN access node's 532 identification and associated data is stored in the remote repository 520, then access procedures and credentials respectively associated with the wireless LAN access node 532, the client node 202, and the user of the client node 202, are retrieved from the remote depository 520. In one embodiment, the access procedures and credentials are communicated to the client node 202 over the connection to the mobile wireless network 506. In another embodiment, the access procedures and credentials are communicated over a connection to the communications satellite 516. In another embodiment the access procedures and credentials are communicated over a connection to a local area network (LAN) or second wireless LAN that the client node 202 may be attached to. The retrieved access procedures and credentials respectively associated with the wireless LAN access node 532, the client node 202, and the user of the client node 202 are then stored in the client node's 202 local repository 220 of wireless network access node identification, access procedures, and credentials data.

If the client node 202 is not currently connected to a wireless network access node (e.g., the mobile wireless network access node 542), then the client node 202 may observe which wireless network access nodes are transmitting within range of the client node 202 and present the user with the list of available wireless network access nodes so that the user can select which wireless network access node to connect to. In another embodiment, a wireless network access node may be automatically selected by the client node 202 from the list of available wireless network access nodes. In various embodiments, the wireless network access node may be automatically selected based on one or more of:
predetermined business arrangements with the client node's 202 home network operator;
services accessible through the wireless network access node 532;
service providers accessible through the wireless network access node 532;
the quality of the radio link to the wireless network access node 532;
the traffic throughput offered by the wireless network access node 532;
the level of privacy (e.g. encryption algorithm, length of encryption key) used on the radio link to the wireless network access node 532;
the cost to access the wireless network access node 532.
   In the event that more than one wireless LAN access node 532 is available within communication range of the client node 202, the access procedures stored in the client node's 202 local repository 220 may include a procedure for selecting the appropriate wireless LAN access node 532. This may include the client node 202 rescanning its current location to find a preferred wireless network access node.

Once selected, the access procedure and credential data associated with the selected wireless network access node is used to establish a communication session between the client node 202 and the selected wireless network access node. In various embodiments, the access procedures comprise an application (e.g. java code) on the client node 202 to interact with the wireless LAN access network 510 to automatically provide the access credentials (e.g. account name and password) as well as financial credentials (e.g., credit card information). In these and other embodiments, the wireless LAN access network 510 may normally collect access credentials, financial credentials, or both using a series of screen interactions with a user. In these embodiments, an application (e.g. java code) on the client node 202 enables the client node 202 to automatically respond to the screen sequence to enable the client node 202 to establish a communications session with the wireless LAN access node 532. These aforementioned procedures enable the client node 202 to access the wireless network node 532 without requiring interaction between the user and the client node 202.

In various embodiments, the client node 202 maintains a communication session accounting log comprising access time(s) and usage associated with individual wireless network access nodes 532 and 542. In various other embodiments, the client node 202 may not be able to detect a wireless network access node 532 at its current location that meets its wireless network access node selection criteria. In these and other embodiments, in response to a query (sent via an existing connection, e.g. via a mobile wireless access node 542, or via a communications satellite 516, or via a secondary wireless LAN access node 532) comprising the client node's 202 current location, the remote repository of wireless network access node data 520 responds with the location of, and directions to other nearby wireless network access nodes that may provide services to the client node 202. In various embodiments, the procedures for accessing a wireless network access node 532 may require manual actions (e.g. reading of and responding to obscured images) by the user of the client node 202. In these and other embodiments, the local 522 or remote 520 repository of wireless network data supplies appropriate information, credentials and instructions, and in turn, the client node 202 provides the credentials to the user for manual entry. In various embodiments, the access credentials provided by a remote wireless network access data server 518 are temporary, time-limited credentials suitable for a single log-in to the wireless LAN access node 532. In these and other embodiments, a log-in attempt to use the credentials once the time limit has expired, or a log-in attempt to use these credentials for a subsequent login will fail, thus mitigating the fraudulent use of credentials.

A variety of business arrangements between the client node's 202 home operator and the operator(s) of the wireless LAN access node 532 may be implemented in various embodiments. In one embodiment, the wireless LAN access node 532 is operated by the mobile network operator (e.g., home-NodeB or WiFi hot-spot). Accordingly, the remote repository of wireless network access data 520 provides a mapping between the client node's 202 home operator account and the wireless LAN access node 532. In another embodiment, the wireless LAN access node 532 is operated by a third party for which there is no established roaming agreement for the client node 202. Accordingly, the remote repository of wireless network access data 520 provides a mapping from the client node's 202 home operator account to an instrument of local payment (e.g., PayPal or credit card). In this and other embodiments, this financial instrument could be associated with the home network operator or could be specific to the user of the client node 202 and their account. In yet another embodiment, the wireless LAN access node 532 is operated by an enterprise, of which the user of the client node 202 is an employee. Accordingly, the remote repository of fixed wireless network access node data 520 provides a mapping between the client node's 202 home operator account and the employee's identification. Likewise, a variety of business relationships may be implemented in relation to the remote repository of wireless network access data 520. In some embodiments, the remote repository of wireless network access data 520 may be owned or operated by a mobile network operator or an enterprise network operator. Likewise, a mobile network operator or an enterprise network operator may own or operate multiple remote repositories of wireless network access data 520. In other embodiments, the remote repository of wireless network access data 520 may be owned or operated by the manufacturer or provider of the client node 202. In yet other embodiments, the remote repository of wireless network access data 520 may be owned or operated by an independent third party.

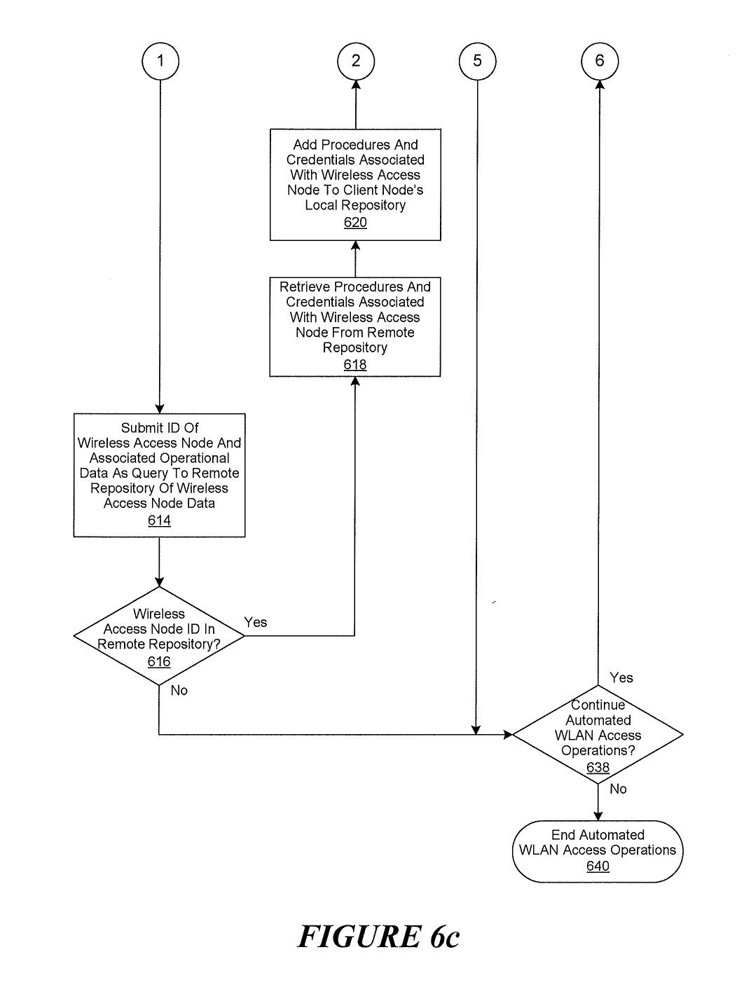

FIG. 6 is a simplified flow chart of operations as implemented in accordance with an embodiment of the disclosure for automating the access to a wireless network access node by a client node. In this embodiment, automated wireless network access operations begin in step 602, followed by a client node monitoring for the presence of at least one wireless network access node in step 604. Examples of wireless network access nodes include WiFi access points, which may be provided by a multiplicity of local network operators, vehicle operators or enterprises, or home node-B (h-NodeB), which may be provided by a multiplicity of network operators and be located in a home, business, or other venue. A determination is then made in step 606 whether the client node detects the presence of a previously undetected wireless network access node. If so, then the client node collects identification (ANID, or SPID, or both), and associated operational data, related to the wireless network access node in step 608.

In step 610, the client node uses the wireless network access node's identification and associated data to query its local repository of wireless network access procedures and credentials data. A determination is then made in step 612 whether the wireless network access node's identification and associated data is stored in the client node's local repository of wireless network access procedures and credentials data. If not, then in step 614 the client node submits the wireless network access node's identification and associated data as a query to a remote repository of wireless network access procedures and credentials data.

A determination is then made in step 616 whether the wireless network access node's identification and associated data is stored in the remote repository of wireless network access procedures and credentials data. If not, then a determination is made in step 638 whether to continue automated wireless network access node access operations. If so, then the process is continued, proceeding with step 604. Otherwise, automated wireless network access node access operations are ended in step 640. However, if it is determined in step 616 that the wireless network access node's identification and associated data is stored in the remote repository, then access procedures and credentials associated with the wireless network access node, the client node, and the user of the client node is retrieved from the remote depository in step 618. In one embodiment, the access procedures and credentials are communicated to the client node over a connection to a mobile wireless network. In another embodiment, the access procedures and credentials are communicated to the client node over a connection to a satellite communications network. In another embodiment, the access procedures and credentials are communicated to the client node over a connection to a wireless LAN network. The retrieved access procedures and credentials associated with the wireless network access node, the client node, and the user of the client node may be then stored in the client node's local repository of wireless network access node access procedures and credentials data in step 620.

Thereafter, or if it was determined in step 606 that the presence of a previously undetected wireless network access node, or in step 612 that the wireless network access node's identification and associated data is not stored in the client node's local repository of wireless network access procedures and credentials data, then a determination is made in step 622 whether the client node is currently connected to a wireless network access node. If not, then the process is continued, proceeding with step 638 as described in greater detail hereinabove. Otherwise, a determination is made in step 624 whether additional wireless network access nodes are detected. If not, then the process is continued, proceeding with step 638 as described in greater detail hereinabove. Otherwise, a wireless network access node is automatically selected in step 626 to establish a communication session. In various embodiments, the wireless network access node is automatically selected based on one or more of:
predetermined business arrangements with the client node's home network operator;
services accessible through the wireless network access node 532;
service providers accessible through the wireless network access node 532;
the quality of the radio link to the wireless network access node 532;
the traffic throughput offered by the wireless network access node 532;
the level of privacy (e.g. encryption algorithm, length of encryption key) used on the radio link to the wireless network access node 532;
the cost to access the wireless network access node 532.

A determination is then made in step 628 whether access procedure and credential data associated with the selected wireless network access node is stored in the client node's local repository of wireless network access procedures and credentials data. If not, then the process is continued, proceeding with step 624. Otherwise, the access procedure and credential data associated with the selected wireless network access node is used in step 630 to establish a communication session with the client node. If so, then communication operations are then performed in step 632 between the client node and the selected wireless network access node. Thereafter, or if it was determined in step 622 that the client node is not currently connected to a wireless network access node, then a determination is made in step 634 whether to continue the communication session with the wireless network access node. If so, then the process is continued, proceeding with step 632. Otherwise, or if it was determined in step 631 that the access procedures were unsuccessful, then a determination is made in step 636 whether to select another wireless network access node. If so, then the process is continued, proceeding with step 626. Otherwise, a determination is made in step 638 whether to continue automated wireless network access node access operations. If so, then the process is continued, proceeding with step 604. Otherwise, automated wireless network access node access operations are ended in step 640.

Although the described exemplary embodiments disclosed herein are described with reference to automating client node access of a wireless network access node, the present disclosure is not necessarily limited to the example embodiments which illustrate inventive aspects of the present disclosure that are applicable to a wide variety of authentication algorithms. Thus, the particular embodiments disclosed above are illustrative only and should not be taken as limitations upon the present disclosure, as the disclosure may be modified and practiced in different but equivalent manners apparent to those skilled in the art having the benefit of the teachings herein. Accordingly, the foregoing description is not intended to limit the disclosure to the particular form set forth, but on the contrary, is intended to cover such alternatives, modifications and equivalents as may be included within the spirit and scope of the disclosure as defined by the appended claims so that those skilled in the art should understand that they can make various changes, substitutions and alterations without departing from the spirit and scope of the disclosure in its broadest form.

1-38. (canceled)

39. A client node for wireless communication, the client node configured to:
receive identification data from a plurality of wireless network access nodes;
automatically select an individual access node from among the plurality of wireless network access nodes based upon one of the group consisting of: a business arrangement with a home network operator of the client node, a service provider accessible via the individual access node, and a level of privacy used on a radio link to the individual access node; and
automatically process access procedure data associated with the automatically selected individual access node to establish a communication session between the automatically selected individual access node and the client node.

40. The client node of claim 39, wherein the client node is configured to:
process the identification data to generate a request for the access procedure data corresponding to the identification data and credential data corresponding to the client node;
submit the request to a remote database comprising the requested access procedure data and credential data;
receive the requested access procedure data and credential data from the database; and
process the access procedure data to provide corresponding credential data to the automatically selected individual access node.

41. The client node of claim 39, wherein the client node:
displays a list of access nodes meeting selection criteria;
enables a user of the client node to manually select an access node from the displayed list; and
processes the access procedure data corresponding to the manually selected access node to provide its corresponding credential data to the manually selected access node.

42. The system of claim 41, wherein the credential data comprises financial account data.

43. The client node of claim 39, wherein the identification data comprises at least one:
venue information;
roaming consortium identifier;
network authentication type;
domain name;
civic location;
geospatial location;
available subscription service providers;
access network type;
implemented radio access technology (RAT);
Service Set Identifier (SSID);
Media Access Control (MAC) address;
wide area cell site identification; or
physical location coordinates.

44. The client node of claim 39, wherein based upon a location determination of the client node with respect to any of the plurality of wireless network access nodes, a remote database automatically provides the access procedure data to the client node for any of the plurality of wireless network access nodes corresponding to the location determination.

45. The client node of claim 44, wherein the client node initiates a request to the remote database based upon a suspicion that the client node is near any of the plurality of wireless network access nodes.

46. The client node of claim 44, wherein the remote database suggests at least one wireless network access node for the client node to access based upon the location determination of the client node.

47. A system, comprising:
a database comprising identification data and access procedure data associated with a plurality of wireless access networks, and credential data associated with a client node, each wireless access network comprising at least one individual access node, the at least one individual access node providing associated identification data to the client node; and wherein
the client node is configured to automatically select an access node associated with one of the plurality of wireless access networks based upon one of the group consisting of: a business arrangement with a home network operator of the client node, a service provider accessible via the access node, and a level of privacy used on a radio link to the access node, the client node comprising processing logic for performing automated access operations in a wireless-enabled communications environment, the processing logic used by the client node comprising logic to automatically obtain the access procedure data associated with the access node that is automatically selected from the database and to use the access procedure data and the credential data to establish a communication session between the client node and the access node that is automatically selected.

48. The system of claim 47, wherein the client node:
processes the identification data to generate a request for the access procedure data corresponding to the identification data and the credential data corresponding to the client node;
submits the request to the database comprising the requested access procedure data and credential data;
receives the requested access procedure data and credential data from the database; and
processes the access procedure data to provide corresponding credential data to the access node.

49. The system of claim 47, wherein the database further comprises:
processing logic for performing automated access operations in a wireless-enable communications environment, the processing logic used by the database to provide the access procedure data and the credential data to an individual client node of a plurality of client nodes, the access procedure data and the credential data used by the individual client node to automatically access the access node; and wherein
the database receives access node identification data and client node identification data from an individual client node, the access node identification data corresponding to an individual wireless network access node of the plurality of wireless network access nodes and the client node identification data corresponding to the individual client node of the plurality of client nodes; and
the database automatically processes the access node identification data and the client node identification data to identify access procedure data corresponding to the individual wireless network access node and credential data corresponding to the individual client node.

50. The system of claim 49, wherein the database:
provides the corresponding access procedure data and the credential data to the individual client node.

51. The system of claim 49, wherein the database:
has no access procedure data corresponding to the access node identification data;
processes the access node identification data to identify access node identification data corresponding to a second individual wireless network access node proximate to the individual wireless network access node corresponding to the access node data;
processes the corresponding access node identification data and the client node identification data to identify access procedure data corresponding to the second individual wireless network access node and credential data corresponding to the individual client node; and
provides the corresponding access procedure data and the credential data to the individual client node.

52. The system of claim 51, wherein the database processes the access node identification data to identify a wireless access network comprising a plurality of wireless access nodes, the individual access node is among the plurality of wireless access nodes, and the database provides the access procedure data and the credential data corresponding to the wireless access network to the individual client node.

53. A method for automating client node access to a wireless network access node, comprising:
accessing a database coupled to a communications network via a client node, the database comprising identification data and access procedure data associated with a plurality of wireless network access nodes and credential data associated with the client node; and
performing automated access operations in a wireless-enabled communications environment via the client node, the database locating access procedure data associated with the identification data;
automatically selecting, via the client node, an individual access node from among the plurality of wireless network access nodes based upon one of the group consisting of: a predetermined business arrangement associated with the client node, a service provider accessible through the individual access node, and a level of privacy used on a radio link to the individual access node; and
automatically accessing the individual access node that is automatically selected at the client node using corresponding access procedure data received from the database to establish a communication session between the individual access node and the client node.

54. The method of claim 53, wherein
the individual access node provides associated identification data to the client node; and
the client node automatically processes the identification data to send a query to the database, the database responding to the query with the associated access procedure data.

55. The method of claim 53, wherein:
the client node processes the access procedure data to provide corresponding credential data to the individual access node.

56. The method of claim 55, wherein the credential data comprises financial account data.

57. The method of claim 53, wherein:
the individual access node provides associated identification data to the client node;
the client node processes the identification data to generate a request for the access procedure data corresponding to the identification data and the credential data corresponding to the client node;
the client node submits the request to the database comprising the requested access procedure data and credential data;
the database provides the requested access procedure data and credential data to the client node; and
the client node processes the access procedure data to provide corresponding credential data to the individual access node.

58. The method of claim 53, wherein based upon a location determination of the client node with respect to any of a plurality of wireless network access nodes, the database automatically provides the access procedure data to the client node for any of the plurality of wireless access nodes corresponding to the location determination.
